(19) United States
(12) Patent Application Publication
(10) Pub. No.: US 2023/0267499 A1
(43) Pub. Date: Aug. 24, 2023

(54) APPROACHES TO PREDICTING THE IMPACT OF MARKETING CAMPAIGNS WITH ARTIFICIAL INTELLIGENCE AND COMPUTER PROGRAMS FOR IMPLEMENTING THE SAME

(71) Applicant: Tickr, Inc., San Francisco, CA (US)

(72) Inventors: Samuel Henry KAHN, Mammoth Lakes, CA (US); Timothy John WILLIAMS, Mesa, AZ (US)

(21) Appl. No.: 18/172,634

(22) Filed: Feb. 22, 2023

Related U.S. Application Data
(60) Provisional application No. 63/313,609, filed on Feb. 24, 2022.

(51) Int. Cl. G06Q 30/0242; G06N 20/00

(52) U.S. Cl. CPC G06Q 30/0242; G06N 20/00

(57) ABSTRACT

One of the most challenging problems that marketing professionals face is measuring the effect of advertising campaigns on the sales of a product. One of the main causes of poorly allocated spend is incorrect analysis of advertising campaign effectiveness. Introduced here is an approach to determining advertising campaign effectiveness in a more accurate, dependable manner using machine learning to extract the true effect of an advertising. This approach can be implemented by a data analysis platform that is able to train a machine learning algorithm using company-specific data as part of a training operation, as well as implementing the resulting machine learning model as part of an inferencing operation.

This application claims priority to U.S. Provisional Application No. 63/313,609, titled “Predicting the Impact of Marketing Campaigns with Artificial Intelligence” and filed on Feb. 24, 2022, which is incorporated by reference herein in its entirety.

### TECHNICAL FIELD

Various embodiments concern computer programs and associated computer-implemented techniques for predicting the impact of marketing campaigns through automated retrieval and analysis of relevant information.

### BACKGROUND

Marketing is the process of exploring, creating, and delivering value to meet the needs of a target market in terms of goods or services. Marketing can take various forms, including selecting an audience to be targeted, identifying attributes to emphasize, and operating advertising campaigns. The term “advertising campaign” generally refers to a series of advertisement messages that share an idea in common. This idea is the central theme to be emphasized in the advertisement messages, and therefore is the prime focus of the advertising campaign. Simply put, this idea governs the objective of the advertising campaign.

Advertising campaigns are designed, constructed, or otherwise developed to accomplish an objective. Consider, for example, an advertising campaign in which advertisement messages are delivered over a media channel to induce purchase of a product by extolling its attributes. Other possible objectives include distributing knowledge of the product, increasing awareness of the product, and aggrandizing the rate of conversions to sales.

Historically, effectiveness measures (also called “effectiveness metrics”) have been used to determine the success of advertising campaigns. Examples of effectiveness metrics include click through rate, conversion rate, and retention rate. While these effectiveness metrics provide some insight, their usefulness tends to be limited—especially as advertising campaigns become more sophisticated, stretching across different media channels, target markets, and the like. As an example, these effectiveness metrics may be unreliable if the goal of an advertisement message is to convert a potential consumer from one media channel (e.g., a social media program) to another media channel (e.g., a web browser). Moreover, these effectiveness metrics are largely unsuitable for establishing which of multiple factors influenced an event, such as the sale of product, as the impacts of these factors can be difficult to isolate. This is especially true for advertising campaigns that extend over several weeks or months, as spontaneous events—such as a natural disaster or a viral moment, like the publication of information regarding a formal or informal spokesperson—will make these effectiveness metrics less reliable, particularly if compared to effectiveness metrics computed for similar timeframes during which similar spontaneous events did not occur.

### BRIEF DESCRIPTION OF THE DRAWINGS

This patent or application publication contains at least one drawing that is executed in color. Copies of this patent or application publication with color drawings will be provided by the Office upon request and payment of the necessary fee.

FIG. 1 shows five years' worth of simulated weekly sales data.

FIG. 2 also shows five years' worth of simulated weekly sales data, with the addition of another line indicating the forecasted sales predicted by the machine learning model.

FIG. 3 shows a probability density function for performance of the machine learning model.

FIG. 4 includes a plot illustrating how the mean absolute percentage error compares against varying amounts of advertising campaign effect.

FIG. 5 includes an example of an intuitive interface that includes two graphs of time-based data.

FIG. 6 illustrates a network environment that includes an analysis platform that is executed by a computing device.

FIG. 7 illustrates an example of a computing device illustrates an example of a computing device that is able to implement an analysis platform designed to predict performance of a company absent an advertising campaign, so as to better understand how the advertising campaign impacted performance.

FIG. 8 includes a flow diagram of a process for developing a model that is able to predict performance of a company in the absence of an advertising campaign that occurred.

FIG. 9 includes a flow diagram of a process for training a machine learning algorithm and then implementing the resulting machine learning model as part of an inferencing operation, in order to predict performance of a company in the absence of an advertising campaign.

FIG. 10 is a block diagram illustrating an example of a processing system in which at least some of the operations described herein can be implemented.

Various features of the technology described herein will become more apparent to those skilled in the art from a study of the Detailed Description in conjunction with the drawings. While certain embodiments are depicted in the drawings for the purpose of illustration, those skilled in the art will recognize that alternative embodiments may be employed without departing from the principles of the technology. The technology is amenable to various modifications.

### DETAILED DESCRIPTION

One of the most challenging problems that marketing professionals face is measuring the effect of advertising campaigns on the sales of a product. However, deciding budget allocation, identifying successful strategies, and maximizing sales and return on investment (“ROI”) may be guided by understanding such relationships. Companies with poorly allocated spend that results in attenuation of sales regularly seek assistance in improving outcomes. One of the main causes of poorly allocated spend is incorrect analysis of advertising campaign effectiveness. Introduced here is an approach to determining advertising campaign effectiveness in a more accurate, dependable manner using machine learning to extract the true effect of an advertising campaign, for example, on sales, ROI, or another business metric. As further discussed below, this approach can be implemented by a data analysis platform (or simply “analysis platform”) that is embodied as a computer program executing on a computing device.

Measuring the impact of advertising campaigns is difficult, even for companies with sophisticated marketing teams or data science teams. Trend, seasonality, holidays, noise, spontaneous events or periodic events, and latent factors that influence data generation can lead analyses astray and impact decision-making processes. To address this issue, the analysis platform can implement, execute, or otherwise support a causal impact analysis tool (or simply “tool”) to allow marketing teams to extract the true effect of advertising campaigns in the presence of the aforementioned factors. Simply put, the tool may allow the impact of the aforementioned factors—singularly and cumulatively—to be better understand. In the present disclosure, embodiments are described in the context of simulated business time series and advertisement campaigns in order to evaluate the performance of the tool under different (e.g., complex) conditions and establish that performance is acceptable.

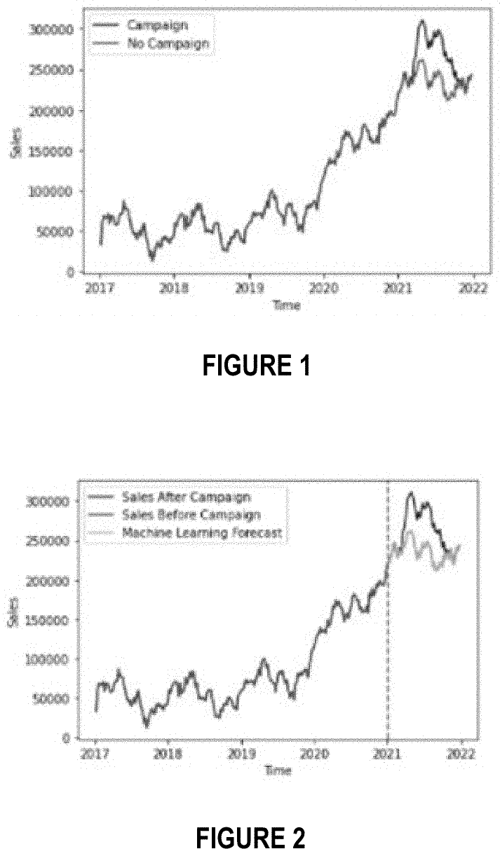

Consider, as an example, the five years' worth of simulated weekly sales data in red in FIG. 1. This data exhibits quarterly and yearly seasonality, a quasi-logistic growth trend, stochastic noise, and an advertising campaign that is run at the beginning of the fifth year. Sales increase during the first six months of the advertising campaign before reverting to previous levels, as shown in blue. A common—yet incorrect—way that companies often measure the impact of an advertising campaign is to compare data to the same time during a previous cycle. For example, a company that runs an advertising campaign in December 2021 may compare the data to December 2020 to measure its impact. Alternatively, the impact of the advertising campaign may be measured by comparing data against a preceding timeframe. For example, a company that runs an advertising campaign in the fourth quarter of 2021 may compare the data to the third quarter of 2021. The problem with these approaches is that the process by which data is generated is not constant. Variations in trend, seasonality, and latent factors in the process itself will lead to incorrect conclusions (and therefore, improper future actions).

By subtracting the “no campaign” data from the “campaign” data, the true effect of the advertising campaign can be established. Referring to FIG. 1, for example, the true effect of the advertising campaign over 2021 is roughly $1,350,000. Now, if this value were simplistically compared to the prior year (i.e., 2020), one might conclude that the advertising campaign had an effect of roughly $5,010,000. But this is a 271 percent overestimate of the true effect of the advertising campaign. Making decisions based on this analysis can (and does) lead to unoptimized allocations of spend and attenuated business potential.

This type of analysis may be further exacerbated by spontaneous events that influence sales in an unpredictable or unknown manner. For example, the COVID-19 pandemic destabilized consumer packaged goods (“CPG”) supply chains and introduced seasonal aberrations. Other events—like viral moments, natural disasters, personnel strikes, and the like—can have similar effects. A marketing manager for a CPG company, following a similar analysis as above, may believe that the advertising campaign introduced in 2021 was highly effective and then decide to overinvest in this marketing channel. Unfortunately, this decision would be grounded in flawed analysis.

There are methods that have traditionally been used to remove seasonality and trend from time-based series of business data, making the data “stationary,” that could improve the above analysis. However, these traditional methods rarely work well in practice. For example, for time-based series of business data, these traditional methods require true knowledge of the trend and seasonality, something that is seldom available in practice. Furthermore, these traditional methods cannot model the effects of holidays and events, and these traditional methods do not utilize sophisticated algorithms (e.g., to detect changes in trend) to better model the underlying signal.

As mentioned above, some companies have begun employing or utilizing sophisticated teams of marketing professionals and/or data science professionals in an effort to address the downsides of these traditional methods. Sophisticated teams may use more advanced statistical techniques, such as difference-in-difference schemes, to measure the impact of advertising campaigns. These statistical techniques do not work in all situations, however. For example, difference-in-difference schemes fail to incorporate empirical priors and account for the temporal evolution of marketing impact. Moreover, difference-in-difference schemes cannot accommodate multiple sources of variation, such as seasonality, local trends, and the time-dependent influence of covariates. Difference-in-difference schemes also fail when the causal effect between treatment and control varies, which is typical for time-based series of business data. When applied by the analysis platform, the tool can solve these common pitfalls.

At a high level, the tool can measure the impact of advertising campaigns, product launches, events, or any other treatment that a company would like to know the impact of. In an ideal scenario, determining the effect of an advertising campaign would amount to knowing the sales of a product without running the advertising campaign and with running the advertising campaign. This is obviously not realistic in the real world as the scenarios are mutually exclusive of one another. However, machine learning can help simulate one of these scenarios to better understand the upsides and downsides of introducing advertising campaigns.

Assume, for example, a company that introduced an advertising campaign is interested in determining its actual effect. In order to determine what would have happened had the advertising campaign not been run, the analysis platform can train a machine learning algorithm (or simply “algorithm”) to predict performance using data leading up to the introduction of the advertising campaign. Specifically, the analysis platform may obtain, as input, a temporal series of data corresponding to an interval of time, and then the analysis platform can separate the temporal series of data into a first dataset corresponding to the timeframe preceding the introduction of the advertising campaign and a second dataset corresponding to the timeframe over which the advertising campaign occurs. Note that, in some embodiments, the temporal series of data may include a third dataset corresponding to the timeframe following the conclusion of the advertising campaign. The analysis platform can train the algorithm using the first dataset, so as to produce a trained machine learning model (or simply “model”) that is able to predict performance absent advertising. Note that the algorithm is generally not trained with the third dataset, if one is present or available, as data included in the third dataset will be influenced by the advertising campaign. While the model generally predicts performance in terms of sales or revenue, other metrics—like popularity (e.g., determined by social media followers), virality (e.g., determined by social media “likes” or shares), relevance (e.g., determined by social media mentions), traffic (e.g., determined based on visits to a website or downloads of a mobile application), and the like—could be predicted in a similar manner.

This algorithm can be trained in a tailored manner for the company, and therefore can be tuned, either autonomously or manually, to the company's data using a statistical modeling technique. One example of an appropriate statistical modeling technique is called Bayesian structural time series. Once trained, the algorithm is representative of a model that is able to parse through data provided as input to produce a prediction (also called an “output”). The model may comprise one or more state variables that can be added together in a weighted manner. As an example, a version of the model may include state variables for trend, seasonality, and regression for contemporaneous covariates, and the weight for each state variable can be learned through analysis of the data provided for training purposes. In true Bayesian fashion, the analysis may use spike-and-slab priors for the state variables to allow the model to regularize and perform feature selection. A spike-and-slab prior for a random variable X is a generative model (i.e., a prior) in which X either attains some fixed value v—called the “spike”—or is drawn toward some other prior p_{slab} (X)—called the “slab.”

Finally, to perform inference, the analysis platform may use a Hamiltonian Monte Carlo algorithm (also called a “hybrid Monte Carlo algorithm”) to find the Bayesian posterior distribution. The Hamiltonian Monte Carlo algorithm is a Markov chain Monte Carlo method for obtaining a sequence of random samples that converge to being distributed according to a target probability distribution for which direct sampling is difficult. This sequence of random samples can be used by the analysis platform to estimate integrals with respect to the target distribution; said another way, this sequence of values can be used by the analysis platform to compute expected values. Accordingly, the Bayesian posterior distribution can be used by the analysis platform to generate a forecast for sales. The forecasted sales—which serves as the control series—can be compared against the true sales—which serves as the treatment series—while the advertising campaign is being run. At a high level, the forecast predicted by the model can be thought of as a counterfactual to what actually happened when the advertising campaign was run.

Generally, the analysis platform is agnostic to how data is ingested, retrieved, or otherwise obtained. For example, the analysis platform may support acquisition of data through Representational State Transfer (“REST”) application programming interfaces (“APIs”), database connectors, and direct upload of files, such as comma-separated value (“CSV”) files and Microsoft Excel files. After the data has been acquired by the analysis platform, the tool may use two types of time-based series of data. The analysis platform may use sales data for the product to be impacted by the advertising campaign and similar time-based series of data to help improve the accuracy of results. The sales data may be treated as the dependent variable to be forecasted, and the similar time-based series of data may relate to products, markets, or companies that aren't affected by the advertising campaign. The additional time-based series of data can be thought of as enriching information intended to improve the model's confidence and ability to extract the true effect of the advertising campaign. With all of this information, the tool can then determine the true impact of the advertising campaign with respect to whichever key performance indicator (“KPI”) the company is interested in measuring.

To better understand how the tool works, consider the graph shown in FIG. 2. FIG. 2 appears similar to FIG. 1, but now three colored lines are plotted. The red line represents the sales of a product before the treatment (i.e., the advertising campaign) is applied, the blue line represents the sales over the next year during and after the treatment, and the orange line represents the forecasted sales predicted by the model over that same time period. The effect of the advertising campaign can be thought of as the delta between the blue and orange lines, essentially subtracting the orange line from the blue line. While this is an oversimplification, it is intuitively and conceptually sound for understanding how the tool works.

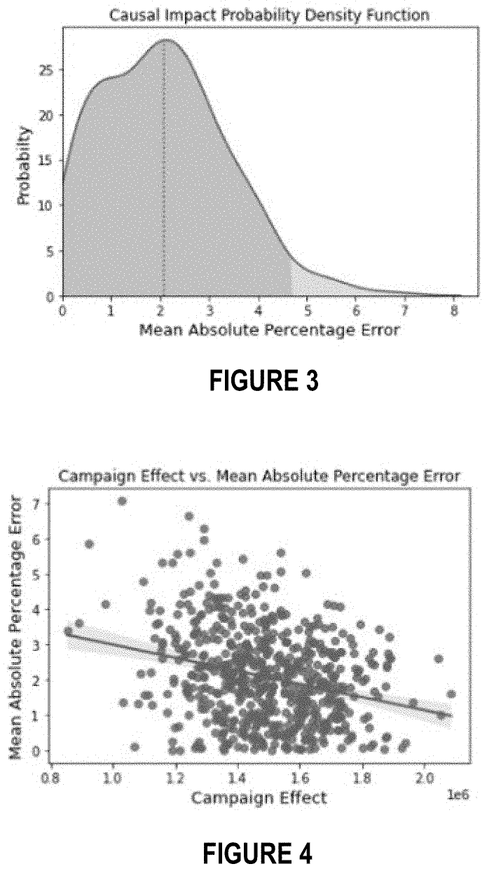

Now, consider the absolute performance, measured in mean absolute percentage error to be agnostic to effect size. In order to accurately measure the performance, the analysis platform can use simulated sales and advertising campaigns, so as to compare the measured impact output by the tool to the true impact. To measure performance, the model was tested against 500 simulated sales and advertising campaigns. For the tool, the 95 percent confidence interval for mean absolute percentage error is 2.1 percent±2.6 percent. The probability density function for performance of the model is shown in FIG. 3.

Overall, performance is remarkable. The true impact of the advertising campaigns was measured within a small margin of error across 500 simulated time-based series of data with varying levels of seasonality, trend, and noise, demonstrating the scalability and robustness of the tool. With the tool, the analysis platform can provide users with actionable insights into advertising campaigns, including how to more efficiently spend to maximize sales and ROI.

It has been found that the larger the advertising campaign or true effect from the advertising campaign, the more confidently the tool can extract the true signal. This roughly linear relationship is shown in FIG. 4. Specifically, FIG. 4 includes a plot illustrating how the mean absolute percentage error compares against varying amounts of advertising campaign effect. The plot shows that the larger the advertising campaign effect, the more accurate the tool generally is. While the effect is relatively small, it may still be worth considering while running advertising campaigns and analyzing results of those advertising campaigns. Accordingly, the analysis platform may program, train, or tune the tool to account for the “largeness” of the advertising campaign of interest, such that the size of the advertising campaign effect is automatically taken into consideration.

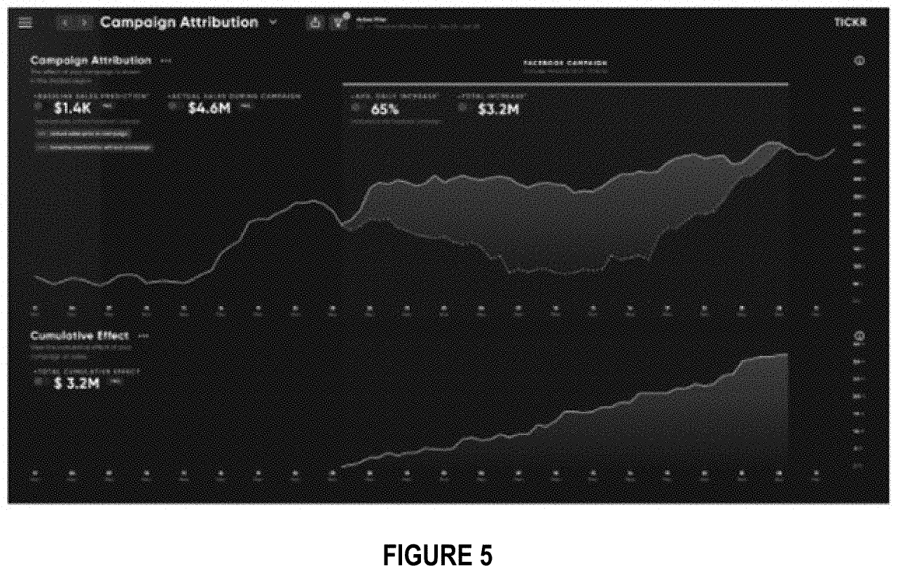

One important piece of the tool is not only its rigorous data science, but how users are able to interact with its models. To accomplish this, the analysis platform may generate or support an intuitive interface through which users can track the causal impact of advertising campaigns. This intuitive interface may be called the “campaign attribution interface.” FIG. 5 includes an example of an intuitive interface that includes two graphs of time-based data. The top graph shows the sales of a company, with the green line indicating the sales after the advertising campaign was initiated, the gray line indicating the sales before the advertising campaign was initiated, and the dashed gray line indicating the forecasted sales predicted by the model. As mentioned above, the causal impact can be thought of as the distance between the green line and dashed gray line. In the lower graph, the cumulative (i.e., additive) impact of the advertising campaign is shown in terms of dollar sales.

The cumulative impact may be computed, inferred, or otherwise derived by the analysis platform based on an analysis of the forecasted sales (and more specifically, a comparison of the forecasted sales to the actual sales). By showing the cumulative effect proximate (e.g., adjacent) to campaign attribution, the analysis platform can more clearly illustrate the impact of the advertising campaign. This approach to visualizing the impact may be helpful as some individuals may find visual comparison of the traces corresponding to actual and forecasted sales to be difficult to fully understand, particularly since both traces may have significant variation over time as shown in FIG. 5.

This holistic view into the impact of advertising campaigns allows users to determine the effect of advertising campaigns as they unfold. Generally, each user is associated with (e.g., an employee of) a company for which an advertising campaign has been, or is to be, run. This holistic view empowers companies to spend less on advertising, gain real-time insights into what is working, and maximize the impact of marketing efforts.

### Overview of Analysis Platform

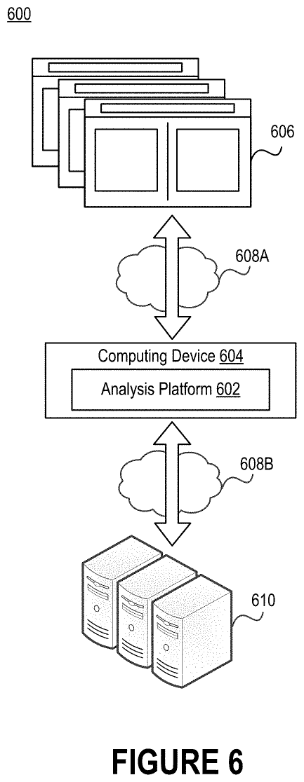

FIG. 6 illustrates a network environment 600 that includes an analysis platform 602 that is executed by a computing device 604. Individuals (also referred to as “users”) may be able to interface with the analysis platform 602 via interfaces 606. For example, a user may be able to access an interface through she can upload data to which a model is to be applied for training or inferencing purposes, as discussed above. As another example, a user may be able to access an interface through which she can review data produced by a model and analyses thereof. One example of such an interface is shown in FIG. 5. Some interfaces may be designed or configured for uploading of data, while other interfaces may be designed or configured for comparing data and analyses thereof. Accordingly, a user may be able to access different interfaces offering different features or functionalities, and these different interfaces may be part of a “user console” through which the user can provide input to, and review outputs from, the analysis platform 602.

As shown in FIG. 6, the analysis platform 602 may reside in a network environment 600. Thus, the computing device 604 on which the analysis platform 602 resides may be connected to one or more networks 608A-B. These networks 608A-B may be personal area networks (“PANs”), local area networks (“LANs”), wide area networks (“WANs”), metropolitan area networks (“MANs”), cellular networks, or the Internet. For example, if the computing device 604 is a computer server, then the computing device 604 may be accessible to users via instances of a mobile application that are executing on respective mobile phones that are connected to the Internet via cellular networks or instances of a browser that are executing on respective laptop computers that are connected to the Internet via LANs.

Additionally or alternatively, the computing device 604 can be communicatively coupled to other computing devices over a short-range wireless connectivity technology, such as Bluetooth®, Near Field Communication (“NFC”), Wi-Fi® Direct (also called “Wi-Fi P2P”), and the like. As an example, the analysis platform 602 could be embodied as a mobile application that is executed by a mobile phone or a desktop application that is executed by a laptop computer. In such embodiments, the mobile phone or laptop computer may be communicatively connected—via a wireless communication channel—to a source from which to acquire data to be used for training or inferencing purposes. The data could alternatively be obtained from another computer program executing on the mobile phone or laptop computer. For example, the data may be acquired from another mobile application executing on the mobile phone or another desktop application executing on the laptop computer, or the data may be acquired from the mobile phone or laptop computer directly (e.g., by accessing or retrieving the data from local memory of the mobile phone or laptop computer).

The interfaces 606 may be accessible via a web browser, desktop application, mobile application, or another form of computer program. For example, a user may be able to access interfaces through which data can be input, for training or inferencing purposes, via a mobile application executing on a mobile phone or tablet computer. As another application, a user may be able to access interfaces through which data can be input, for training or inferencing purposes, via a desktop application executing on a laptop computer or desktop computer. As another example, a user may be able to access interfaces through which data can be input, for training or inferencing purposes, via a web browser executing on a mobile phone, tablet computer, laptop computer, or desktop computer. Accordingly, the interfaces 606 generated by the analysis platform 602 may be accessible on various computing devices, including mobile phones, tablet computers, laptop computers, desktop computers, and the like.

Generally, the analysis platform 602 is executed—at least partially—by a cloud computing service operated by, for example, Amazon Web Services®, Google Cloud Platform™, or Microsoft Azure®. Thus, the computing device 604 may be representative of a computer server that is part of a server system 610. Often, the server system 610 is comprised of multiple computer servers. These computer servers can include different types of data (e.g., business data associated with different companies, information regarding sporadic events impacting sales such as commencement date and termination date, and information regarding advertising campaigns such as product of interest, commencement date, and termination date), algorithms for processing the data, and other assets. Those skilled in the art will recognize that this information could also be distributed amongst the server system 610 and one or more computing devices. For example, business data may remain on the computing device used to access the interfaces 606 so long as the computing device has access to the necessary algorithms and model, for security or privacy purposes. As another example, business data associated with different companies could be separately “siloed” (e.g., stored, obfuscated, or processed) by the server system 610 to minimize the risk of unintended disclosure. Note also that sensitive data may not be transmitted to the server system 610 at all, in order to inhibit unauthorized access of the sensitive data. Accordingly, sensitive data that is associated with business data may remain on the computing device used to access the interfaces 606, even if the business data is transmitted to the server system 610. Examples of sensitive data include information regarding purchasers (e.g., name, address, etc.), information regarding the structure, spend, or targeting parameters of the advertising campaign, and the like.

Components of the analysis platform 602 could also be hosted locally. That is, part of the analysis platform 602 may reside on the computing device that is used to access the interfaces 606. For example, the analysis platform 602 may be embodied as a mobile application that is executable by a mobile phone, or the analysis platform 602 may be embodied as a desktop application that is executable by a laptop computer or desktop computer. Note, however, that the mobile application and desktop application may be communicatively connected to the server system 610 on which other components of the analysis platform 602 are hosted.

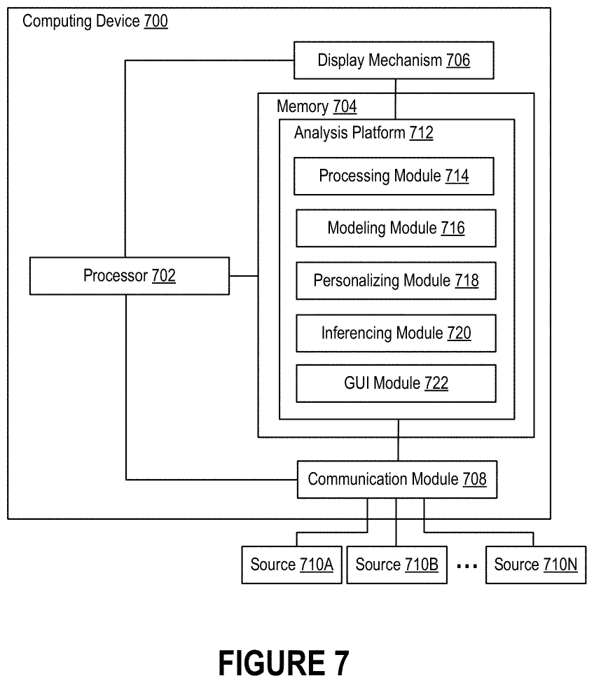

FIG. 7 illustrates an example of a computing device 700 illustrates an example of a computing device 700 that is able to implement an analysis platform 712 designed to predict performance of a company absent an advertising campaign, so as to better understand how the advertising campaign impacted performance. As shown in FIG. 7, the computing device 700 can include a processor 702, memory 704, display mechanism 706, and communication module 708. Each of these components is discussed in greater detail below.

Those skilled in the art will recognize that different combinations of these components may be present depending on the nature of the computing device 700. For example, if the computing device 700 is a computer server that is part of a server system (e.g., server system 610 of FIG. 6), then the computing device 700 may not include the display mechanism 706. Conversely, if the computing device 700 is a mobile phone, tablet computer, or laptop computer, then the computing device 700 can include the display mechanism 706.

The processor 702 can have generic characteristics similar to general-purpose processors, or the processor 702 may be an application-specific integrated circuit (“ASIC”) that provides control functions to the computing device 700. As shown in FIG. 7, the processor 702 can be coupled to all components of the computing device 700, either directly or indirectly, for communication purposes.

The memory 704 can be comprised of any suitable type of storage medium, such as static random-access memory (“SRAM”), dynamic random-access memory (“DRAM”), electrically erasable programmable read-only memory (“EEPROM”), flash memory, or registers. In addition to storing instructions that can be executed by the processor 702, the memory 704 can also store data generated by the processor 702 (e.g., when executing the modules of the analysis platform 712). Note that the memory 704 is merely an abstract representation of a storage environment. The memory 704 could be comprised of actual integrated circuits (also called “chips”).

The display mechanism 706 can be any mechanism that is operable to visually convey information to a user. For example, the display mechanism 706 can be a panel that includes light-emitting diodes (“LEDs”), organic LEDs, liquid crystal elements, or electrophoretic elements. As further discussed below, outputs produced by the analysis platform 712 (e.g., through execution of its modules) can be posted to the display mechanism 706 for review by a user of the computing device 700.

The communication module 708 may be responsible for managing communications external to the computing device 700. The communication module 708 can be wireless communication circuitry that is able to establish wireless communication channels with other computing devices. Examples of wireless communication circuitry include 2.4 gigahertz (“GHz”) and 5 GHz chipsets compatible with Institute of Electrical and Electronics Engineers (“IEEE”) 802.11—also called “Wi-Fi chipsets.” Alternatively, the communication module 708 may be representative of a chipset configured for Bluetooth, NFC, and the like. Some computing devices—like mobile phones, tablet computers, and the like—are able to wirelessly communicate via multiple channels, while other computing devices—like computer servers—tend to wirelessly communicate via a single channel. Accordingly, the communication module 708 may be one of multiple communication modules implemented in the computing device 700, or the communication module 708 may be the only communication module implemented in the computing device 700.

The nature, number, and type of communication channels established by the computing device 700—and more specifically, the communication module 708—can depend on (i) the sources from which data is received by the analysis platform 712 and (ii) the destinations to which data is transmitted by the analysis platform 712. Assume, for example, that the analysis platform 712 resides on a computer server. In such embodiments, the communication module 708 can communicate with sources 710A-N external to the computing device 700 from which to obtain data. For example, the sources 710A-N may be representative of repositories of respective companies (e.g., Company A, Company B, . . . , Company N) for which data is to be analyzed. Moreover, the communication module 708 may communicate with one or more destinations to which analyses of the data—or the data itself—are transmitted. For example, the destinations may be representative of computing devices associated with representatives of the respective companies. The term “representative” may be used to refer to an employee of a company or a marketing professional that works on behalf of the company (e.g., as part of a marketing agency).

For convenience, the analysis platform 712 is referred to as a computer program that resides within the memory 704. However, the analysis platform 712 could be comprised of software, firmware, or hardware that is implemented in, or accessible to, the computing device 700. In accordance with embodiments described herein, the analysis platform 712 can include a processing module 714, modeling module 716, personalizing module 718, inferencing module 720, and graphical user interface (“GUI”) module 722. These modules could be integral parts of the analysis platform 712, or these modules could be logically separate from the analysis platform 712 but operate “alongside” it. Together, these modules may be representative of a causal impact analysis tool (or simply “tool”) that enables the analysis platform 712 to train a model to produce an output that is representative of a prediction regarding performance in the absence of an advertising campaign and apply the model to data to accomplish the same.

The processing module 714 can process data that is obtained by the analysis platform 712—for either training or inferencing purposes—into a format that is suitable for the other modules. For example, the processing module 714 may have access to data regarding performance (e.g., measured in terms of sales, revenue, profit, or another metric such as popularity, virality, relevance, etc.) for each of multiple companies. In some embodiments, this data is received or retrieved by the analysis platform 712 from sources external to the computing device 700 (e.g., sources 710A-N) and then stored, at least temporarily, in the memory 704. In other embodiments, this data is accessed by the analysis platform 712 but not stored in the memory 704. Accordingly, this data could remain external to the computing device 700 (e.g., in sources 710A-N) in some embodiments. The processing module 714 can apply operations to this data acquired from sources 710A-N in preparation for analysis by the other modules of the analysis platform 712. For instance, the processing module 714 may filter or alter this data, such that this data can be more readily analyzed. As an example, the processing module 214 may parse different kinds of data (e.g., relating to sales, revenue, and popularity on a social media platform) associated with a company and then ensure that the data is temporally arranged so that any insights gleaned through analysis can be taken into context. As mentioned above, the analysis platform 712 could train models using these different kinds of data, and as such, be able to infer how an advertising campaign influenced multiple KPIs (e.g., the advertising campaign may have moderately influenced popularity on the social media platform and significantly influenced sales). Accordingly, the analysis platform 712 may train models corresponding to different KPIs, such that the corresponding company can better understand how an advertising campaign affects these different KPIs. This can be helpful as an advertising campaign may have different and/or unpredictable effects on KPIs. For example, an advertising campaign carried out via a social media platform may be designed to increase brand awareness, and in such a scenario, an effect on popularity (e.g., as measured by “likes” or “follows” on the social media platform) may be expected while an effect on website traffic may be largely unexpected or at least unpredictable. Models designed to predict KPIs can be trained on corresponding sets of data (e.g., indicating “likes,” “follows,” or “mentions” on social media, sales, impressions, etc.) separately to understand impact on different KPIs.

The modeling module 716 may be responsible for training an algorithm using data that is processed by the processing module 714. Assume, for example, that the analysis platform 712 obtains a temporal series of data corresponding to an interval of time. The processing module 714 may parse this data and then segment this data into a first dataset corresponding to the timeframe preceding the introduction of an advertising campaign and a second dataset corresponding to the timeframe over which the advertising campaign occurred. The modeling module 716 can train an algorithm using the first dataset, so as to produce a trained model that is able to predict performance absent advertising. As mentioned above, the trained model can predict preference in terms of whichever KPI is used in the first dataset. While performance is generally measured in terms of sales or revenue, performance could be measured using another metric such as popularity, virality, relevance, traffic, and the like.

In some embodiments, the algorithm is trained in a tailored manner for the company, and the personalizing module 718 may be responsible for accomplishing or facilitating this. Referring again to the aforementioned example, the personalizing module 718 may autonomously tune the trained model to the first dataset using a statistical modeling technique. For example, the trained model may include one or more state variables that are added together in a weighted manner when applied to data for the purpose of producing an output that is representative of predicted performance absent advertising. These state variables may represent various characteristics that influence the output. For example, the model could include state variables for trend, seasonality, and repression for contemporaneous covariates, and the weight of each state variable could be learned through analysis of the first dataset used for training.

The inferencing module 720 may be responsible for employing the trained model to produce an output that is representative of predicted performance. Said another way, the inferencing module 720 may be responsible for using the trained model to performance an inferencing operation (also called an “predicting operation”). To perform the inferencing operation, the inferencing module 720 may apply the trained model to the second dataset that corresponds to the timeframe over which the advertising campaign occurred. As output, the trained model may produce another temporal data series, indicating how performance is predicted to vary over the same timeframe absent the advertising campaign.

As a specific example, the inferencing module 720 could use a Monte Carlo algorithm (e.g., a hybrid Monte Carlo algorithm) to find the Bayesian posterior distribution of the output produced by the trained model upon being applied to the second dataset. The Monte Carlo algorithm may be a Markov chain Monte Carlo method for obtaining a sequence of random samples that converge to being distributed according to a target probability distribution for which direct sampling is difficult. The inferencing module 720 can use the sequence of random samples to estimate integrals with respect to the target distribution, and thereby compute expected values for the appropriate KPI. The forecasted values for the KPI can be compared against the actual values for the KPI included in the second dataset, which serves as the treatment series.

Generally, the analysis platform 712 is agnostic to how data is ingested, retrieved, or otherwise obtained. For example, the analysis platform 712 may support—and be responsible for deploying or enabling—REST APIs or database connectors. Additionally or alternatively, the analysis platform 712 may support direct upload of files, such as CSV files and Microsoft Excel files, through an interface generated by the GUI module 722. Regardless of how the data is ingested, retrieved, or otherwise obtained, the processing module 714 may be responsible for examining the data to ensure that it is suitable for the other modules of the analysis platform 712 as discussed above.

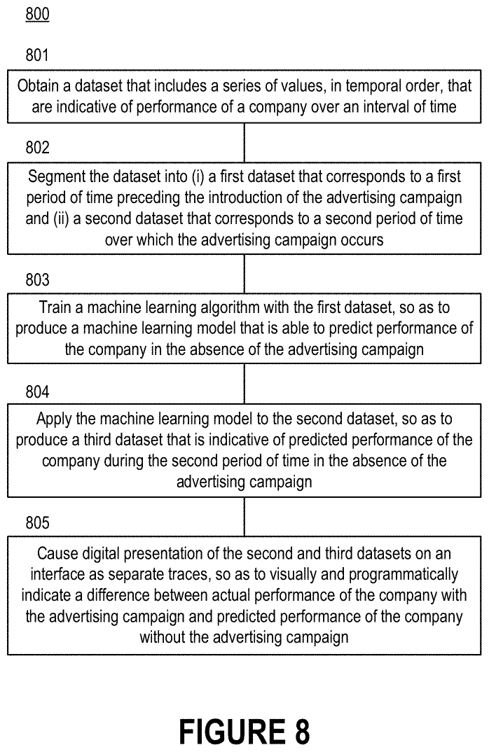

FIG. 8 includes a flow diagram of a process 800 for developing a model that is able to predict performance of a company in the absence of an advertising campaign that occurred. Initially, an analysis platform can obtain a dataset that includes a series of values, in temporal order, that are indicative of performance of a company over an interval of time (step 801). As mentioned above, performance could be measured using various KPIs including sales, revenue, and the like. Generally, the process 800 is agnostic to the nature of the KPI, so long as the values correspond to the KIP at various points in time across the interval of time. For example, the values included in the series may correspond to the KPI as periodically measured at hourly, daily, or weekly intervals, or the values included in the series may correspond to the KPI as measured in an ad hoc manner.

Then, the analysis platform can segment the dataset into (i) a first dataset that corresponds to a first period of time preceding the introduction of an advertising campaign and (ii) a second dataset that corresponds to a second period of time over which the advertising campaign occurs (step 801). The first and second periods of time may be representatives of different subsets of the interval of time. For example, the first period of time may immediately precede the second period of time. Note that the first and second periods of time do not (and usually are not) the same length. Thus, the length of the first period of time may be different (e.g., shorter or longer) than the length of the second period of time. However, each period of time may need to be at least a predetermined length in order for insights gained through analysis of the corresponding data to be predictive. For example, each period of time may need to be at least 3 days, 7 days, or 14 days.

The analysis platform can then train a machine learning algorithm with the first dataset, so as to produce a machine learning model that is able to predict performance of the company in the absence of the advertising campaign (step 803). In some embodiments, the analysis platform stores the machine learning model in a storage medium in anticipation of using the machine learning model during future inferencing operations. For example, the analysis platform may store the machine learning model in a data structure that is either labelled or has metadata associated therewith specifying its characteristics (e.g., the name of the company, the date of training, a description of the data used for training, etc.).

In other embodiments, the analysis platform immediately uses the machine learning model as part of an inferencing operation. Accordingly, the analysis platform may be designed, programmed, or otherwise configured to dynamically train and implement a machine learning model upon receiving the necessary data. Thus, the analysis platform may apply the machine learning model to the second dataset, so as to produce a third dataset that is indicative of predicted performance of the company during the second interval of time in the absence of the advertising campaign (step 804). As discussed above, the analysis platform may employ a Monte Carlo algorithm to find a posterior distribution (e.g., a Bayesian posterior distribution) of the output produced by the machine learning model upon being applied to the second dataset. The Monte Carlo algorithm may produce, as output, a sequence of random samples across a target probability distribution. The analysis platform may use the sequence of random samples to estimate integrals with respect to the target probability distribution, thereby computing expected values for the KPI by which performance is measured.

Outputs produced by the machine learning model—or analyses of the outputs—can be presented on an interface for review.

For example, the analysis platform may cause digital presentation of the second and third datasets on an interface as separate traces on a graph, as shown in FIG. 2, so as to visually and programmatically indicate a difference between actual performance of the company with the advertising campaign and predicted performance of the company without the advertising campaign (step 805). As shown in FIG. 2, the graph could also include the first dataset that is presented as its own trace. The traces corresponding to the first, second, and third datasets may be visually distinguished from one another (e.g., using different colors, hash types, stroke widths, etc.).

As another example, the analysis platform may cause digital presentation of metrics inferred, determined, or computed based on the second and third datasets. For example, the analysis platform may determine the total benefit, in terms of performance, by comparing the second dataset to the third dataset. As another example, the analysis platform may determine the comparative benefit, in terms of performance, by comparing the total benefit to the cost of running the advertising campaign. While the primary interest of most companies is generally return on investment—namely, whether the advertising campaign results in KPI improvements that balance the associated costs—other metrics may be valuable. For example, the analysis platform may monitor aspects like conversion rate of advertisement viewers or listeners into purchasers. As another example, the analysis platform may monitor whether an advertising campaign is successfully broadening appeal by convincing viewers or listeners into first-time customers, or whether an advertising campaign is successfully deepening interest by convincing past customers to again purchase products from the company.

The process 800 could also include additional steps not shown in FIG. 8. For example, the analysis platform may tune the machine learning model to personalize for the company in an autonomous manner using a statistical modeling technique, such as Bayesian structural time series. Additionally or alternatively, the analysis platform may tune the machine learning model to personalize for characteristics of the industry in which the company competes. Consider, for example, a scenario where the machine learning model includes one or more state variables that, as part of the inferencing operation, are summed in a weighted manner to establish predicted performance. These state variables could be used to programmatically represent aspects like trend, seasonality, and regression that tend to influence performance in a variable manner. For each state variable, the corresponding weight may be learned through analysis of the first dataset that is provided to the machine learning algorithm as part of the training operation.

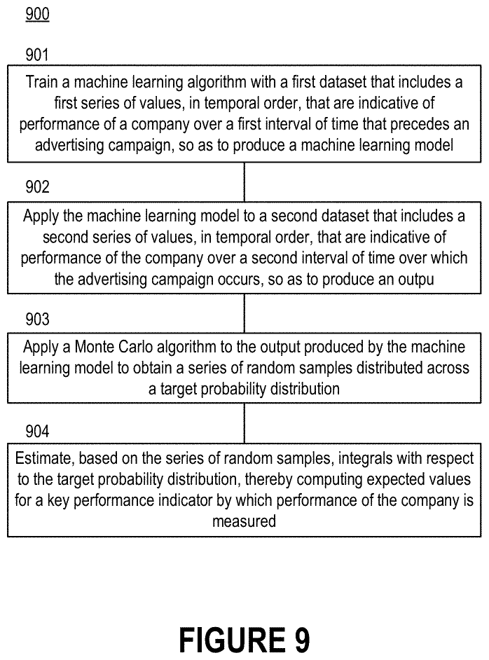

FIG. 9 includes a flow diagram of a process 900 for training a machine learning algorithm and then implementing the resulting machine learning model as part of an inferencing operation, in order to predict performance of a company in the absence of an advertising campaign. Initially, an analysis platform can train a machine learning algorithm with a first dataset that includes a first series of values, in temporal order, that are indicative of performance of the company over a first interval of time that precedes an advertising campaign, so as to produce a machine learning model (step 901). Step 901 of FIG. 9 may be similar to step 803 of FIG. 8.

Thereafter, the analysis platform can apply the machine learning model to a second dataset that includes a second series of values, in temporal order, that are indicative of performance of the company over a second interval of time over which the advertising campaign occurs, so as to produce an output (step 902). The analysis platform can then further process the output. For example, the analysis platform may apply a Monte Carlo algorithm to the output produced by the machine learning model to obtain a series of random samples distributed across a target probability density (step 903). The target probability density may correspond to the second interval of time over which performance is to be predicted. In some embodiments, the Monte Carlo algorithm is based on a Markov chain Monte Carlo approach to sampling from the target probability distribution, as discussed above.

Then, the analysis platform can estimate, based on the series of random samples, integrals with respect to the target probability distribution, thereby computing expected values for a KPI by which performance of the company is measured (step 904). The analysis platform may cause digital presentation of the expected values or analyses thereof on an interface that is accessible to a user.

As mentioned above, the machine learning model that is employed by the analysis platform could include one or more state variables that, as part of the inferencing operation, are summed in a weighted manner to establish predicted performance. For each state variable, the corresponding weight may be learned through analysis of the first dataset provided to the machine learning algorithm as part of the training operation. A spike-and-slab prior could be used for each state variable to allow the machine learning model to regularize and perform feature selection. At a high level, for each state variable, the corresponding spike-and-slab prior is representative of a generative model in which that state variable either attains a fixed value or is drawn toward another value.

Note that in some embodiments, the processes 800, 900 described above are initiated in response to input being received from a user through an interface. For example, the analysis platform may generate and then cause digital presentation of an interface through which the user is able to select the datasets to be used during the training operation and/or inferencing operation. In such a scenario, the analysis platform may obtain the datasets in response to receiving input that is indicative of the selection made by the user. The datasets could be obtained via a REST API or database connector as mentioned above. As another example, the analysis platform may generate and then cause digital presentation of an interface through which the user is able to directly upload one or more files that include the datasets to be used during the training operation and/or inferencing operation. As a specific example, the analysis platform may permit direct upload of CSV files or spreadsheet files (e.g., created using Microsoft Excel or Google Sheets).

Unless contrary to physical possibility, it is envisioned that the steps described above may be performed in various sequences and combinations. For example, the processes could be performed as data is acquired, directly or indirectly, from companies, such that analysis of advertising campaigns happens in real time. This may be helpful as it allows those companies to made decisions in real time about which advertising campaigns are worth continuing and which advertising campaigns are worth terminating. Historically, marketing professionals have been responsible for providing these recommendations in near real time (i.e., as the advertising campaigns are ongoing); however, these recommendations are often based on “gut feel” as information regarding the counterfactual—namely, where the advertising campaign did not occur—is not available.

Other steps may also be included in some embodiments. For example, the processes could be performed multiple times, at different times, for the same advertising campaign in order to better understand whether the company benefits from keeping the advertising campaign “live.” Consider, for example, a scenario where an advertising campaign is set to run for three months. After one month, the analysis platform may discover that the advertising campaign resulted in significant improvement in performance. However, the analysis platform may discover that the advertising campaign resulting in mediocre improvement in performance after two months. In such a scenario, the company may be warned that performance is getting worse, at least in the sense that performance is reverting to what would be expected in the absence of the advertising campaign. Such information may be helpful as the company could terminate the advertising campaign, thereby saving costs, or adjust the advertising campaign by altering its targeting parameters, total spend, creative materials, etc. This type of dynamic, ongoing analysis can also be helpful for companies that tend to run advertising campaigns indefinitely. Through periodic or ad hoc analysis, the analysis platform can identify when the advertising campaign is no longer resulting in gains in performance.

### Processing System

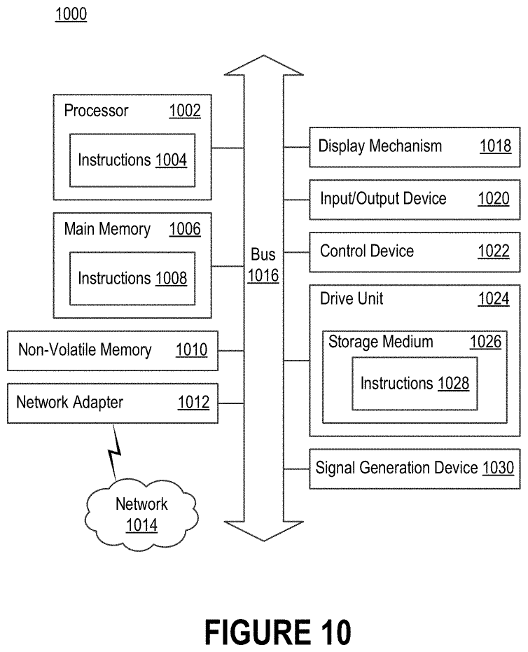

FIG. 10 is a block diagram illustrating an example of a processing system 1000 in which at least some of the operations described herein can be implemented. For example, components of the processing system 1000 may be hosted on a computing device that includes an analysis platform, or components of the processing system 1000 may be hosted on a computing device with which a user interacts with an analysis platform (e.g., via interfaces).

The processing system 1000 may include a processor 1002, main memory 1006, non-volatile memory 1010, network adapter 1012, display mechanism 1018, input/output device 1020, control device 1022, drive unit 1024 including a storage medium 1026, or signal generation device 1030 that are communicatively connected to a bus 1016. Different combinations of these components may be present depending on the nature of the computing device in which the processing system 1000 resides. For example, in embodiments where the processing system 1000 is part of a computer server, the display mechanism 1018 and/or control device 1022 may not be included.

The bus 1016 is illustrated as an abstraction that represents one or more physical buses or point-to-point connections that are connected by appropriate bridges, adapters, or controllers. Thus, the bus 1016 can include a system bus, a Peripheral Component Interconnect (“PCI”) bus or PCI-Express bus, a HyperTransport bus, an Industry Standard Architecture (“ISA”) bus, a Small Computer System Interface (“SCSI”) bus, a Universal Serial Bus (“USB”) interface, Inter-Integrated Circuit (“I²C”) bus, or an IEEE 1394 bus (also called “FireWire”).

While the main memory 1006, non-volatile memory 1010, and storage medium 1026 are shown to be a single medium, the terms “machine-readable medium” and “storage medium” should be taken to include a single medium or multiple media (e.g., a centralized or distributed database and associated caches and computer servers) that store one or more sets of instructions 1028. The terms “machine-readable medium” and “storage medium” shall also be taken to include any medium that is capable of storing, encoding, or carrying instructions for execution by the processing system 1000.

In general, the routines executed to implement embodiments of the present disclosure may be implemented as part of an operating system or a specific computer programs. A computer program typically comprises instructions (e.g., instructions 1004, 1008, 1028) set at various times in various memory and storage devices in a computing device. When read and executed by the processor 1002, the instructions cause the processing system 1000 to perform operations in accordance with aspects of the present disclosure.

Further examples of machine- and computer-readable media include recordable-type media, such as volatile memory devices and non-volatile memory devices 1010, removable disks, hard disk drives, and optical disks (e.g., Compact Disk Read-Only Memory (“CD-ROMS”) and Digital Versatile Disks (“DVDs”)), and transmission-type media, such as digital and analog communication links.

The network adapter 1012 enables the processing system 1000 to mediate data in a network 1014 with an entity that is external to the processing system 1000 through any communication protocol supported by the processing system 1000 and the external entity. The network adapter 1012 can include a network adaptor card, a wireless network interface card, a router, an access point, a wireless router, a switch, a multilayer switch, a protocol converter, a gateway, a bridge, a bridge router, a hub, a digital media receiver, a repeater, or any combination thereof.

### Terminology

References in the present disclosure to “an embodiment” or “some embodiments” means that the feature, function, structure, or characteristic being described is included in at least one embodiment. Occurrences of such phrases do not necessarily refer to the same embodiment, nor do they necessarily refer to alternative embodiments that are mutually exclusive of one another.

The terms “comprise,” “comprising,” and “comprised of” are to be construed in an inclusive sense rather than an exclusive or exhaustive sense (i.e., in the sense of “including but not limited to”).

The term “based on” is also to be construed in an inclusive sense rather than an exclusive or exhaustive sense. Thus, unless otherwise noted, the term “based on” is intended to mean “based at least in part on.”

The terms “connected,” “coupled,” and variants thereof are intended to include any connection or coupling between two or more elements, either direct or indirect. The connection or coupling can be physical, logical, or a combination thereof. For example, elements may be electrically or communicatively connected to one another despite not sharing a physical connection.

The term “module” may refer broadly to software, firmware, hardware, or combinations thereof. Modules are typically functional components that generate one or more outputs based on one or more inputs. A computer program may include or utilize one or more modules. For example, a computer program may utilize multiple modules that are responsible for completing different tasks, or a computer program may utilize a single module that is responsible for completing multiple tasks.

When used in reference to a list of items, the word “or” is intended to cover all of the following interpretations: any of the items in the list, all of the items in the list, and any combination of items in the list.

### REMARKS

The foregoing description of various embodiments of the claimed subject matter has been provided for the purposes of illustration and description. It is not intended to be exhaustive or to limit the claimed subject matter to the precise forms disclosed. Many modifications and variations will be apparent to one skilled in the art. Embodiments were chosen and described in order to best describe the principles of the claimed subject matter and its practical applications, thereby enabling those skilled in the relevant art to understand the claimed subject matter, the various embodiments, and the various modifications that are suited to the uses contemplated.

Although the Detailed Description describes certain embodiments, the technology can be practiced in many ways no matter how detailed the Detailed Description appears. Embodiments may vary considerably in their implementation details, while still being encompassed by the present disclosure. Terminology that is used when describing certain embodiments should not be taken to imply that the terminology is being redefined herein to be restricted to any specific characteristics, features, or aspects of the technology with which that terminology is associated. In general, the terms used in the following claims should not be construed to limit the technology to the specific embodiments described in the Detailed Description, unless those terms are explicitly defined herein. Accordingly, the actual scope of the technology encompasses not only the disclosed embodiments, but also all equivalent ways of practicing or implementing the technology.

The language used in the present disclosure has been principally selected for readability and instructional purposes. It may not have been selected to delineate or circumscribe the technology. It is therefore intended that the scope of the present disclosure be limited not by the Detailed Description, but rather by any claims that issue on an application based hereon. Accordingly, the disclosure of embodiments is intended to be illustrative, but not limiting, of the scope of the technology as set forth in the following claims.

What is claimed is:

1. A non-transitory medium with instructions stored thereon that, when executed by a processor of a computing device, cause the computing device to perform operations comprising:
obtaining a dataset that includes a series of values, in temporal order, that are indicative of performance of a company over an interval of time;
segmenting the dataset into—
(i) a first dataset corresponding to a first period of time preceding an introduction of an advertising campaign, wherein the first period of time is representative of a subset of the interval of time, and
(ii) a second dataset corresponding to a second period of time over which the advertising campaign occurs, wherein the second period of time is representative of another subset of the interval of time;
training a machine learning algorithm with the first dataset, so as to produce a machine learning model that is able to predict performance of the company in the absence of the advertising campaign;
applying the machine learning model to the second dataset, so as to produce a third dataset that is indicative of predicted performance during the second period of time in the absence of the advertising campaign; and
causing digital presentation of the second and third datasets on an interface as separate traces, so as to visually and programmatically indicate a difference between performance of the company with the advertising campaign and predicted performance of the company without the advertising campaign.

2. The non-transitory medium of claim 1, wherein the interface also includes the first dataset that is presented as a trace.

3. The non-transitory medium of claim 1, wherein the operations further comprise:
tuning the machine learning model for the company in an autonomous manner using a statistical modeling technique.

4. The non-transitory medium of claim 3, wherein the statistical modeling technique is a Bayesian structural time series.

5. The non-transitory medium of claim 1, wherein the machine learning model includes one or more state variables that, as part of an inferencing operation, are summed in a weighted manner to establish predicted performance.

6. The non-transitory medium of claim 5,
wherein the machine learning model includes separate state variables for trend, seasonality, and regression, and
wherein for each state variable, a corresponding weight is learned through analysis of the first dataset provided to the machine learning algorithm for training purposes.

7. The non-transitory medium of claim 1, wherein the operations further comprise:
employing a Monte Carlo algorithm to find a posterior distribution of an output produced by the machine learning model upon being applied to the second dataset,
wherein the Monte Carlo algorithm produces, as output, a sequence of random samples; and
using the sequence of random samples to estimate integrals with respect to a target distribution, thereby computing expected values for a key performance indicator by which performance is measured.

8. The non-transitory medium of claim 7, wherein the key performance indicator is sales, revenue, virality, relevance, or traffic.

9. A method performed by a computer program executing on a computing device, the method comprising:
training a machine learning algorithm with a first dataset that includes a first series of values, in temporal order, that are indicative of performance of a company over a first interval of time that precedes an advertising campaign, so as to produce a machine learning model;
applying the machine learning model to a second dataset that includes a second series of values, in temporal order, that are indicative of performance of the company over a second interval of time over which the advertising campaign occurs, so as to produce an output;
applying a Monte Carlo algorithm to the output produced by the machine learning model to obtain a series of random samples distributed across a target probability distribution;
estimating, based on the series of random samples, integrals with respect to the target probability distribution, thereby computing expected values for a key performance indicator by which performance of the company is measured.

10. The method of claim 9, wherein the target probability distribution corresponds to the second interval of time.

11. The method of claim 9, wherein the Monte Carlo algorithm is based on a Markov chain Monte Carlo approach to sampling from the target probability distribution.

12. The method of claim 9, wherein the machine learning model includes one or more state variables that, as part of an inferencing operation, are summed in a weighted manner to establish predicted performance

13. The method of claim 12, wherein for each state variable, a corresponding weight is learned through analysis of the first dataset provided to the machine learning algorithm as part of a training operation, in which a spike-and-slab prior is used for each state variable to allow the machine learning model to regularize and perform feature selection.

14. The method of claim 13, wherein for each state variable, a corresponding spike-and-slab prior is representative of a generative model in which that state variable either attains a fixed value or is drawn toward another value.

15. The method of claim 9, further comprising:
receiving input that is indicative of a selection, made by a user through an interface, of the first and second datasets or another dataset of which the first and second datasets are a part; and
obtaining, in response to said receiving, the first and second datasets or the other dataset.

16. The method of claim 15, wherein the first and second datasets or the other dataset are acquired via a Representational State Transfer (REST) application programming interface (API) or a database connector.

17. The method of claim 9, further comprising:
causing digital presentation of an interface through which a user is able to directly upload one or more files that include the first and second datasets.

18. The method of claim 17, wherein the one or more files are comma-separated value (CSV) files or spreadsheet files.
